(19) United States
(12) Patent Application Publication
(10) Pub. No.: US 2011/0185861 A1
(43) Pub. Date: Aug. 4, 2011

(54) Electronic Torque Wrench

(76) Inventor: Bobby Hu, Taichung City (TW)

(21) Appl. No.: 12/846,879

(22) Filed: Jul. 30, 2010

(30) Foreign Application Priority Data
Feb. 4, 2010 (TW) 99103336

(51) Int. Cl. B25B 23/14

(52) U.S. Cl. 81/467

(57) ABSTRACT

An electronic torque wrench includes a body (10) having a driving portion (12; 15; 16; 17) and a shank (11) interconnected to the driving portion (12; 15; 16; 17). The shank (11) includes a first pivotal portion (112) spaced from the driving portion (12; 15; 16; 17) along a longitudinal axis (A). An object can be driven by the driving portion (12; 15; 16; 17) to rotate about a rotating axis perpendicular to the longitudinal axis (A). A torque sensor (32) is mounted to a detecting portion (111) of the shank (11) intermediate the first pivotal portion (112) and the driving portion (12; 15; 16; 17). A handle (20) includes a second pivotal portion (212) pivotably connected to the first pivotal portion (112). A torque display device (30) is mounted to the handle (20) and electrically connected to the torque sensor (32). The torque sensor (32) detects torque applied from the driving portion (12; 15; 16; 17) to the object and sends a signal indicative of the torque to the torque display device (30). The torque display device (30) receives the signal and displays a value of the torque.

### BACKGROUND OF THE INVENTION

The present invention relates to an electronic torque wrench and, more particularly, to an angle-adjustable electronic torque wrench allowing precise detection of torque.

Currently available electronic torque wrenches include a handle having a driving portion on an end thereof and a gripping portion on the other end thereof. The driving portion can include a ratchet wheel, a closed end, or an open end. At lease one torque sensor is mounted to an outer periphery of the handle to detect the bending strain of the handle when the electronic torque wrench is applying a force to an object such as a fastener. The torque sensor coverts a change in the strain into a signal that is sent via a wire to a torque display device mounted to the handle. The torque display device includes a torque calculating device that receives the signal and converts the signal into a torque value that is displayed on a display of the torque display device. Thus, the user can immediately know the current torque value applied to the object and can stop rotating the object after a desired torque is applied to the object, obtaining safest securing effect of the object.

The currently available electronic torque wrenches provide precise detection of the bending strain only when the electronic torque wrench is rotated about a longitudinal axis of the object. Namely; the handle must be generally perpendicular to the longitudinal axis of the object during operation. Otherwise, the strain detected by the torque sensor will be imprecise, as the torque imparted to the handle can not generate the maximum bending strain when the rotating axis of the driving portion of the electronic torque wrench is at an acute angle to the longitudinal axis of the object.

Angle-adjustable electronic torque wrenches have been proposed to allow use of the electronic torque wrenches in a limited space. Such angle-adjustable electronic torque wrenches include a handle and a driving portion pivotably connected to the handle, allowing adjustment of an angle between the handle and the driving portion. However, these electronic torque wrenches could not provide precise detection of torque if the rotating axis of the driving portion of the electronic torque wrench is at an acute angle to the longitudinal axis of the object, as mentioned above.

FIG. 1 shows an angle-adjustable electronic torque wrench 40 proposed to solve the problems of above-mentioned electronic torque wrenches 40. Electronic torque wrench 40 includes a handle having a pivotal portion 44 at an end thereof. Pivotal portion 44 includes a groove 441 pivotably receiving an end of a drive member 43. A screw 431 is extended through pivotal portion 44 and the end of drive member 43. An angular position of the drive member 43 relative to the handle can be adjusted. Drive member 43 includes a drive column 41 on the other end thereof for coupling with a socket for the purposes of driving an object such as a fastener in the form of a bolt, nut, or the like. A torque sensor 42 is mounted to an outer periphery of an intermediate portion of drive member 43 and has a coupling portion 422 electrically connected by a wire 421 to a torque display device mounted on the handle. The torque applied to the object can be detected by the torque sensor 42 and displayed on the torque display device.

However, mounting the torque sensor 42 on the drive member 43 requires an increase in the length of the drive member 43, leading to limitation to use of electronic torque wrench 40 in a limited space. Furthermore, torque sensor 42 mounted to the outer periphery of the intermediate portion of drive member 43 is liable to be impinged and, thus, damaged. Further, drive column 41 can only drive a fastener via use of a socket. Namely, torque sensor 42 can not be mounted to electronic torque wrenches of the type having an open end or a closed end.

Thus, a need exists for an electronic torque wrench that can be used in a limited space while providing precise torque detection for differing driving portions.

### BRIEF SUMMARY OF THE INVENTION

The present invention solves this need and other problems in the field of precise detection of torque by providing, in a preferred form, an electronic torque wrench including a body having a driving portion and a shank interconnected to the driving portion. The shank includes a first pivotal portion spaced from the driving portion along a first longitudinal axis. The driving portion is adapted to drive an object to rotate about a rotating axis perpendicular to the first longitudinal axis. The shank includes a detecting portion intermediate the first pivotal portion and the driving portion. A handle includes a gripping section and a second pivotal portion. The second pivotal portion is pivotably connected to the first pivotal portion. A torque display device is mounted to the handle. A torque sensor is mounted to the detecting portion and electrically connected to the torque display device. The torque sensor is adapted to detect torque applied from the driving portion to the object and to send a signal indicative of the torque to the torque display device. The torque display device is adapted to receive the signal and to display a value of the torque.

In a preferred form, the shank includes an engaging section spaced from the first pivotal portion along the first longitudinal axis. The detecting portion is intermediate the first pivotal portion and the engaging section along the first longitudinal axis. The driving portion includes an engaging end releasably engaged with the engaging section.

In another preferred form, the first pivotal portion releasably engaged with the second pivotal portion. An extension is mounted between the first and second pivotal portions. The extension includes a third pivotal portion and a fourth pivotal portion spaced from the third pivotal portion along the first longitudinal axis. The third pivotal portion is pivotably and releasably engaged with the first pivotal portion. The fourth pivotal portion is pivotably and releasably engaged with the second pivotal portion.

In preferred forms, the handle includes a rod having the second pivotal portion. The rod further includes a mounting portion to which the torque display device is mounted. The handle further includes a jacket mounted around the rod. The jacket includes the gripping section. The jacket further includes a window aligned with the mounting portion such that the value of the torque is viewable through the window.

In preferred forms, the second pivotal portion is spaced from the gripping section along a second longitudinal axis. The first pivotal portion is pivotable relative to the second pivotal portion with an angle between the first and second longitudinal axis not larger than 30°.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a partial, perspective view of a conventional electronic torque wrench.

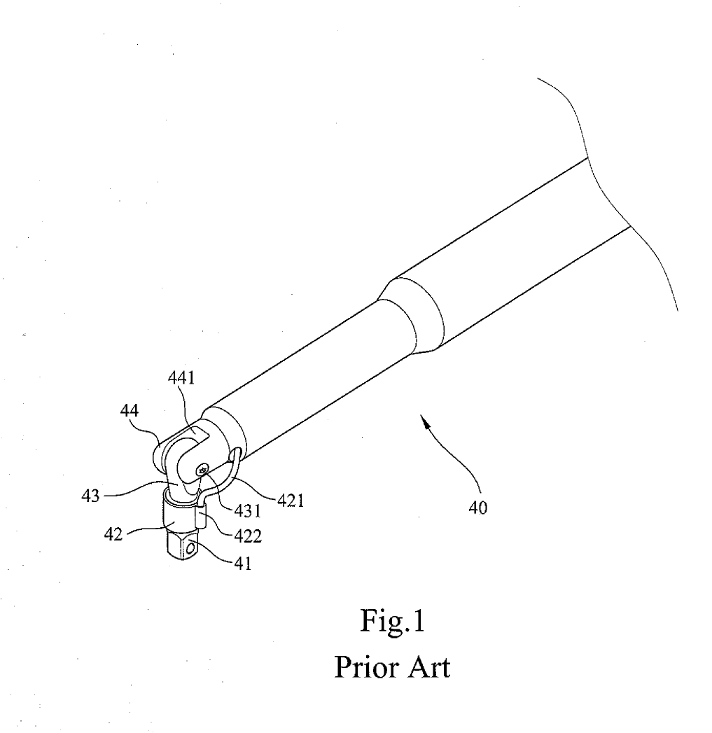

FIG. 2 shows a perspective view of an electronic torque wrench of a first embodiment according to the preferred teachings of the present invention.

FIG. 3 shows an exploded, perspective view of the electronic torque wrench of FIG. 2.

FIG. 4 shows a cross sectional view of the electronic torque wrench of FIG. 2.

FIG. 5 shows a schematic view illustrating use of the electronic torque wrench of FIG. 2 in a limited space with the electronic torque wrench in an angled state.

FIG. 6 shows a perspective view of an electronic torque wrench of a second embodiment according to the preferred teachings of the present invention.

FIG. 7 shows an exploded, perspective view of the electronic torque wrench of FIG. 6.

FIG. 8 shows a cross sectional view of the electronic torque wrench of FIG. 6.

FIG. 9 shows a partial, exploded, perspective view of an electronic torque wrench of an embodiment modified from the first embodiment.

FIG. 10 shows a perspective view illustrating an electronic torque wrench and interchangeable shanks with different driving portions according to the preferred teachings of the present invention.

FIG. 11 shows a perspective view illustrating an electronic torque wrench and interchangeable driving portions according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “outer”, “end”, “portion”, “section”, “longitudinal”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

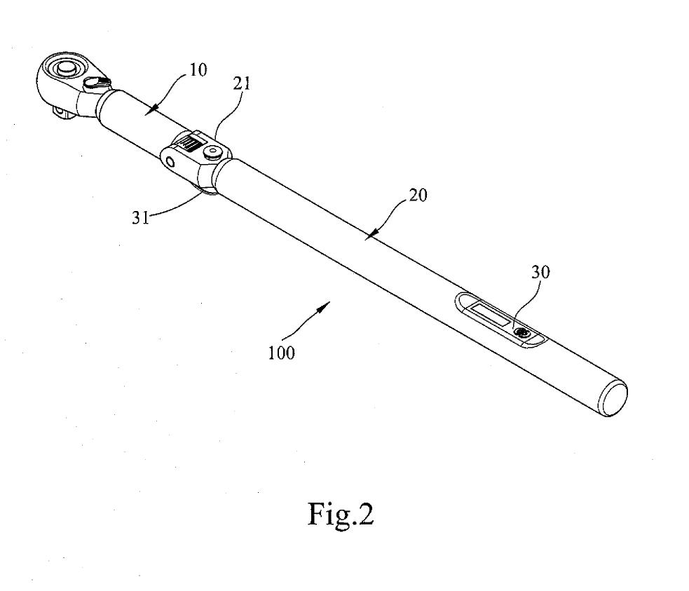

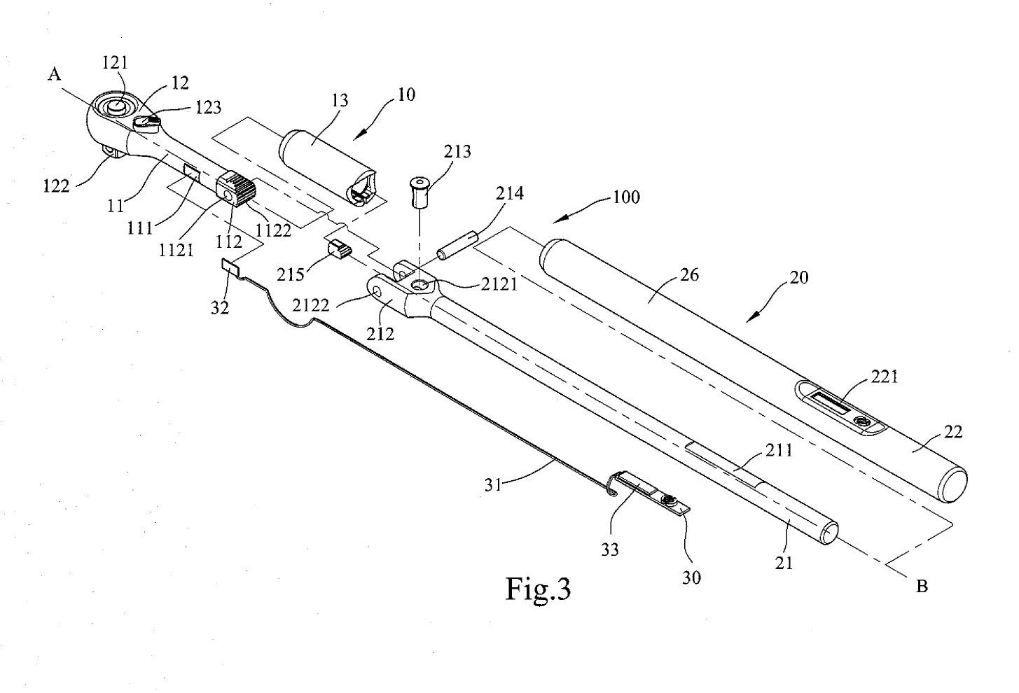

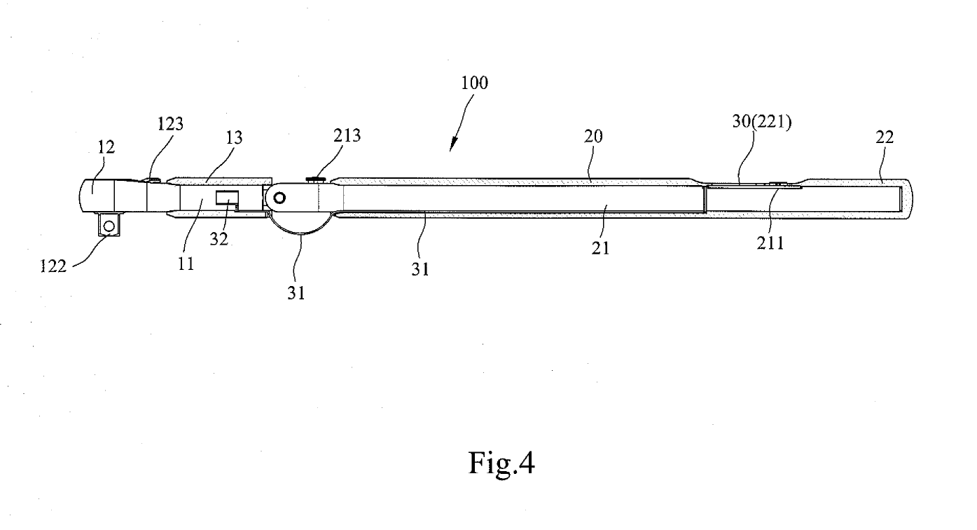

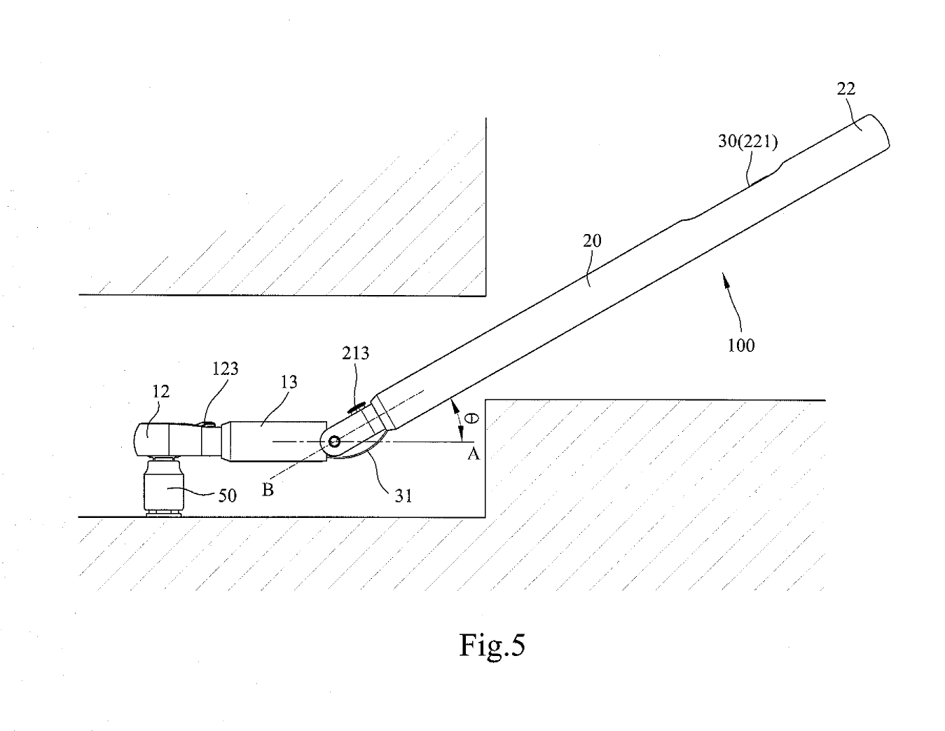

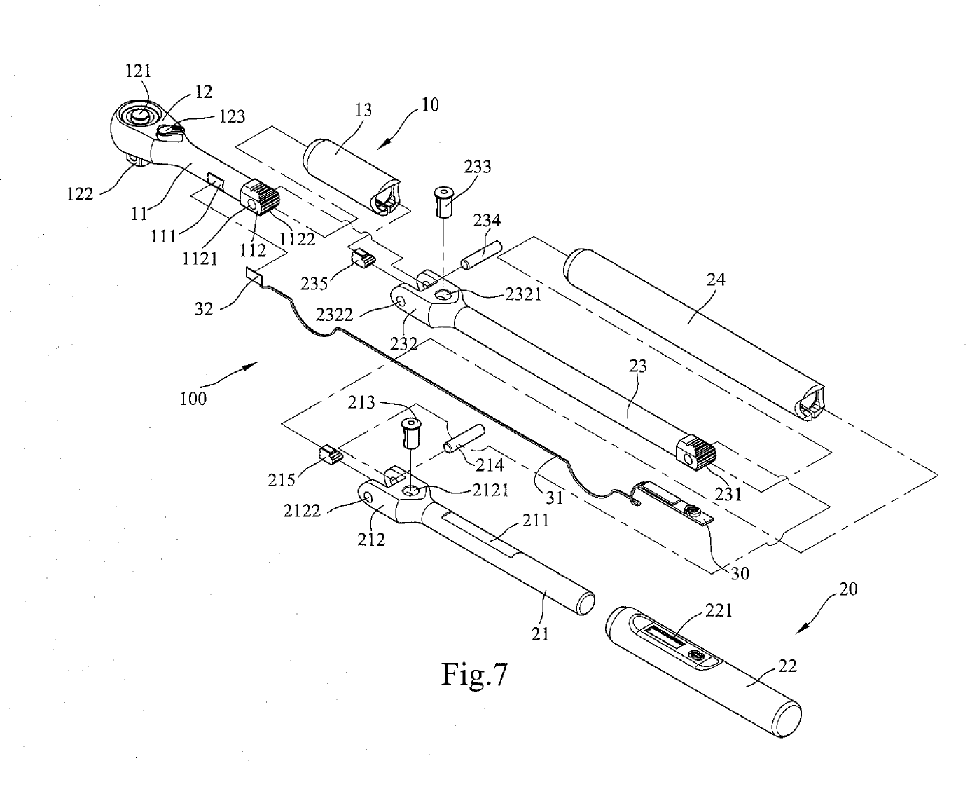

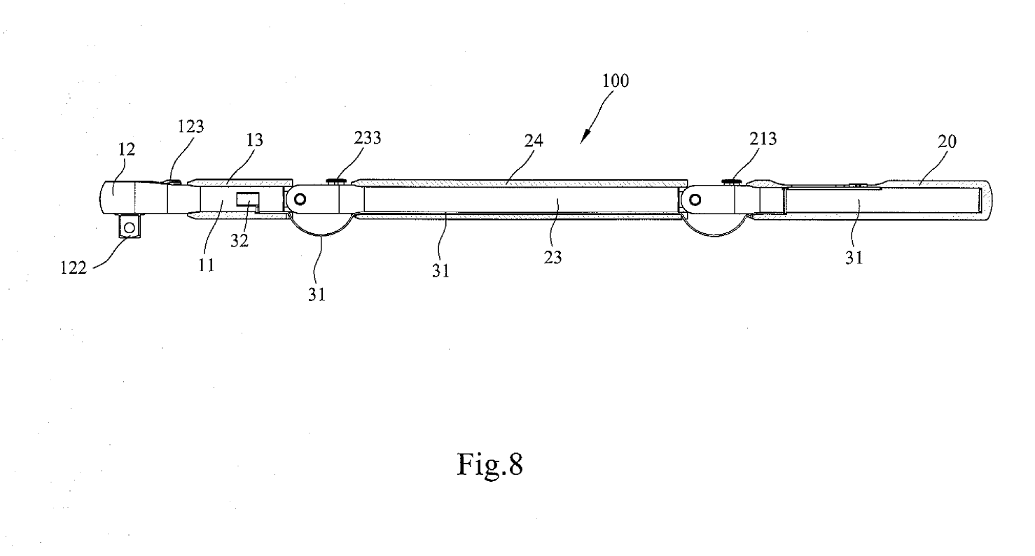

An electronic torque wrench according to the preferred teachings of the present invention is shown in FIGS. 2-11 and generally designated 100. According to a first embodiment shown in FIGS. 2-5, electronic torque wrench 100 includes a body 10, a handle 20, and a torque display device 30. Body 10 includes a driving portion 12 and a shank 11 interconnected to driving portion 12. Driving portion 12 is adapted to directly or indirectly drive an object such as a fastener in the form of a bolt, nut, etc. Driving portion 12 includes a drive column 122 for releasably engaging with a socket. Driving portion 12 is of the type having a ratcheting portion 121 and a switch 123 allowing switching of a driving direction in which the object is driven. However, other types and forms of driving portion 12 can be utilized according to the teachings of the present invention.

Shank 11 includes a pivotal portion 112 spaced from driving portion 12 along a longitudinal axis A. In this embodiment, pivotal portion 112 includes an arcuate toothed portion 1122 having a pivotal hole 1121. Shank 11 further includes a detecting portion 111 in the form of a recess formed in an outer periphery of shank 11 and located intermediate pivotal portion 112 and driving portion 12 along longitudinal axis A. A sleeve 13 made of soft, plastic material is mounted around shank 11 and covers detecting portion 111.

Handle 20 includes a gripping section 22 and a second pivotal portion 212 spaced from gripping section 22 along a longitudinal axis B. In this embodiment, handle 20 includes a rod 21 having a second pivotal portion 212 releasably and pivotably connected to pivotal portion 112. Pivotal portion 212 includes two spaced lugs defining a groove and having aligned pin holes 2122. Pivotal portion 112 is received in the groove between the spaced lugs, and a pin 214 is extended through pin holes 2122 and pivotal hole 1121, allowing relative pivotal movement between pivotal portions 112 and 212. Pivotal portion 212 further includes a hole 2121 receiving a release pin 213. A catch 215 is received in the groove between the spaced lugs and engaged with arcuate toothed portion 1122 to retain driving portion 12 in a fixed angular position relative to handle 20. Release pin 213 can be pushed to disengage catch 215 from arcuate toothed portion 1122, allowing adjustment of the angular position of driving portion 12 relative to handle 20. Namely, an angle θ between longitudinal axes A and B can be adjusted such that electronic torque wrench 100 can be used in a limited space. Preferably, angle θ between longitudinal axes A and B is not larger than 30°. Other forms and shapes of pivotal portions 112 and 212 can be utilized according to the teachings of the present invention. Furthermore, pivotal portions 112 and 212 can be retained in a desired angular position by other provisions other than catch 215 and release pin 214. Rod 21 further includes a mounting portion 211 in the form of a recessed portion to which torque display device 30 is mounted. The recessed portion has a size according to that of torque display device 30. Handle 20 further includes a jacket 26 mounted around rod 26 and having gripping section 22. Jacket 26 is formed of soft, plastic material by injection molding to provide gripping comfort. Other material can be used according to the teachings of the present invention. Jacket 26 includes a window 221 aligned with mounting portion 211. A display 33 of torque display device 30 can be viewed via window 221. Other forms and shapes of handle 20 can be utilized according to the teachings of the present invention.

Torque sensor 32 is mounted to detecting portion 111 and electrically connected to torque display device 30 by a wire 31 that extends along shank 11, around pivotal portions 112 and 212, and along shank rod 21 to torque display device 30. Torque sensor 32 can be in the form of a strain gauge. However, other forms and shapes of torque sensor 32 can be utilized according to the teachings of the present invention. Torque display device 30 includes a torque calculating device and the display 33.

In use, the object, such as a bolt, nut, or the like, is driven by driving portion 12 to rotate about a rotating axis perpendicular to longitudinal axis A through use of a socket 50. Torque applied from driving portion 12 to the object is transmitted to shank 11. Torque sensor 32 detects the strain at detecting portion 111 and sends a signal indicative of the torque to torque display device 30. After calculation by the torque calculating device, a value of the torque is displayed on display 33 and can be viewed via window 221. Since longitudinal axis A of shank 11 is always perpendicular to the rotating axis of the object, the torque imparted to shank 11 and detection of torque sensor 32 will not be affected regardless of the relative angular position between shank 11 and handle 20. Precise detection of the torque applied to the object is, thus, assured. Furthermore, since torque sensor 32 is surrounded by sleeve 13 and since sensor 32 is spaced from drive column 122, damage to torque sensor 32 is avoided or at least significantly reduced. Furthermore, torque sensor 32 mounted to the outer periphery of shank 11 neither increases the volume of the driving portion 12 nor interferes with use of socket 50, allowing convenient use in a limited space.

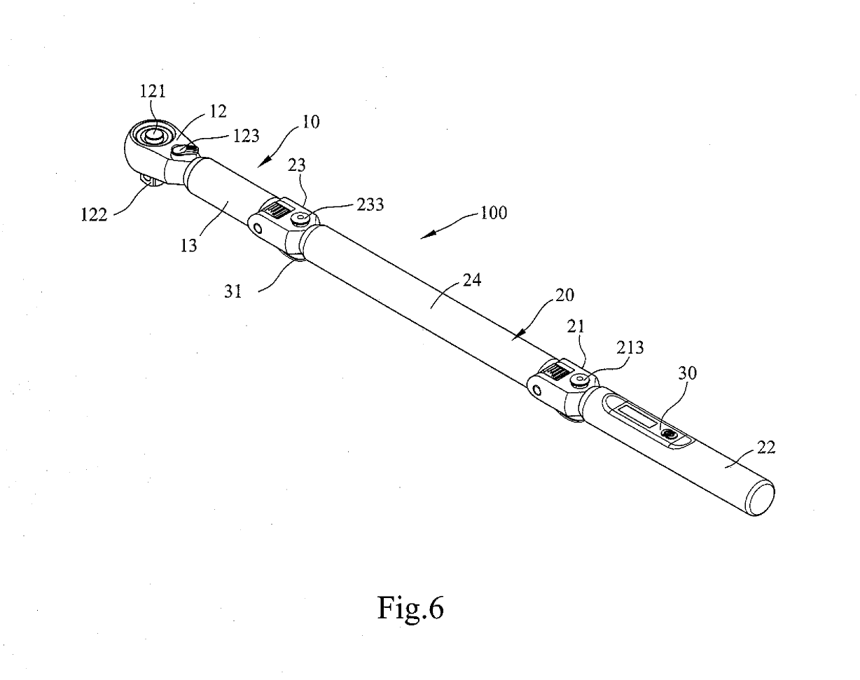

FIGS. 6-8 show electronic torque wrench 100 of a second embodiment according to the preferred teachings of the present invention. Specifically, pivotal portion 112 is disengaged from pivotal portion 212, and, an extension 23 is mounted between pivotal portions 112 and 212. Extension 23 includes two pivotal portions 231 and 232 spaced along longitudinal axis A. Pivotal portion 231 is pivotably and releasably engaged with pivotal portion 112, and pivotal portion 232 is pivotably and releasably engaged with pivotal portion 212. In the illustrated embodiment, pivotal portion 232 includes two spaced lugs defining a groove and having aligned pin holes 2322. Pivotal portion 112 is received in the groove between the spaced lugs of pivotal portion 232, and a pin 234 is extended through pin holes 2322 and pivotal hole 1121, allowing relative pivotal movement between pivotal portions 112 and 232. Pivotal portion 232 further includes a hole 2321 receiving a release pin 233. A catch 235 is received in the groove between the spaced lugs of pivotal portion 232 and engaged with arcuate toothed portion 1122 to retain driving portion 12 in a fixed angular position relative to extension 23. Release pin 233 can be pushed to disengage catch 235 from arcuate toothed portion 1122, allowing adjustment of the angular position of driving portion 12 relative to extension 23. Pivotal portion 231 is in the form of an arcuate toothed portion for pivotal engagement with pivotal portion 212 by pin 214, allowing adjustment of the relative angular position between extension 23 and handle 20. Other forms and shapes of pivotal portions 231 and 232 can be utilized according to the teachings of the present invention. A sleeve 24 made of soft, plastic material can be mounted around extension 23. Due to provision of two pivotal arrangements, electronic torque wrench 100 can be bent in a desired manner for special situations while providing precise detection of the torque applied to the object driven by electronic torque wrench 100.

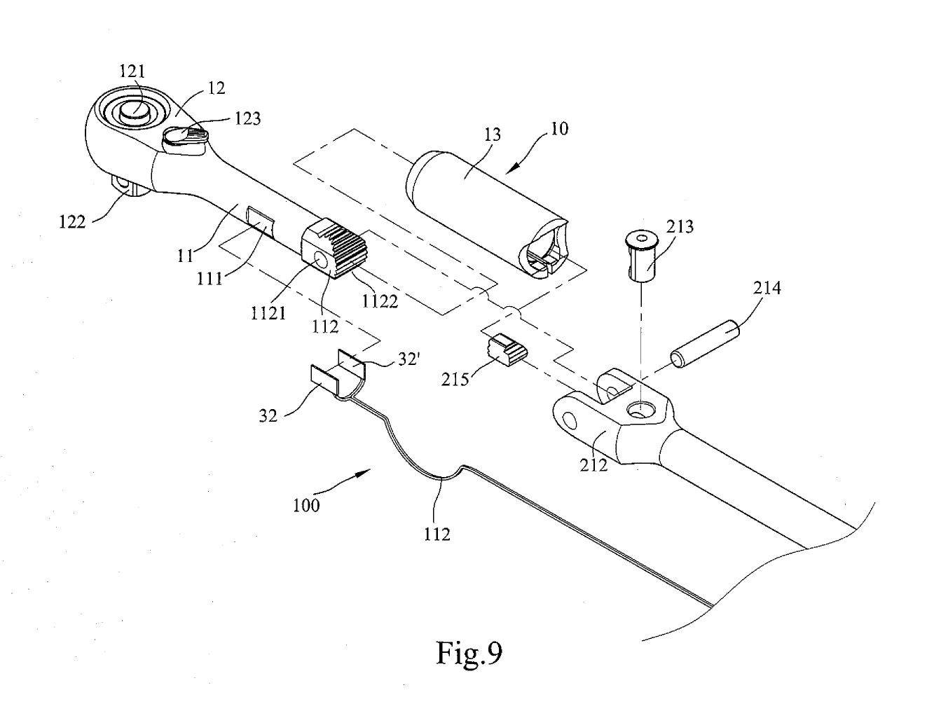

It can be appreciated that shank 11 can include two or more detecting portions 111 receiving two or more torque sensors 32 and 32′ to enhance the detection sensitivity, as shown in FIG. 9.

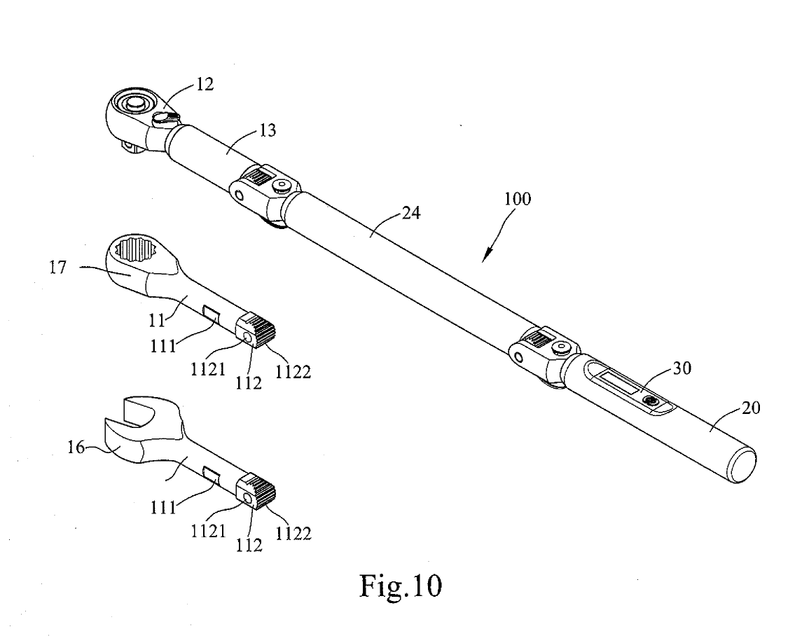

The driving portion on shank 11 can be of any desired forms other than drive portion 12 with switch 123 and ratcheting portion 121. As an example, shank 11 can include a driving portion 16 in the form of an open end of an open-end wrench, as shown in FIG. 10. As another example, shank 11 can include a driving portion 17 in the form of a closed end of a ring spanner, as shown in FIG. 10. However, other forms and shapes of drive portion can be utilized according to the teachings of the present invention. Since pivotal portion 112 can be disengaged from pivotal portion 212 or 232, interchange of driving portions 12, 16, 17 can easily be achieved, if desired.

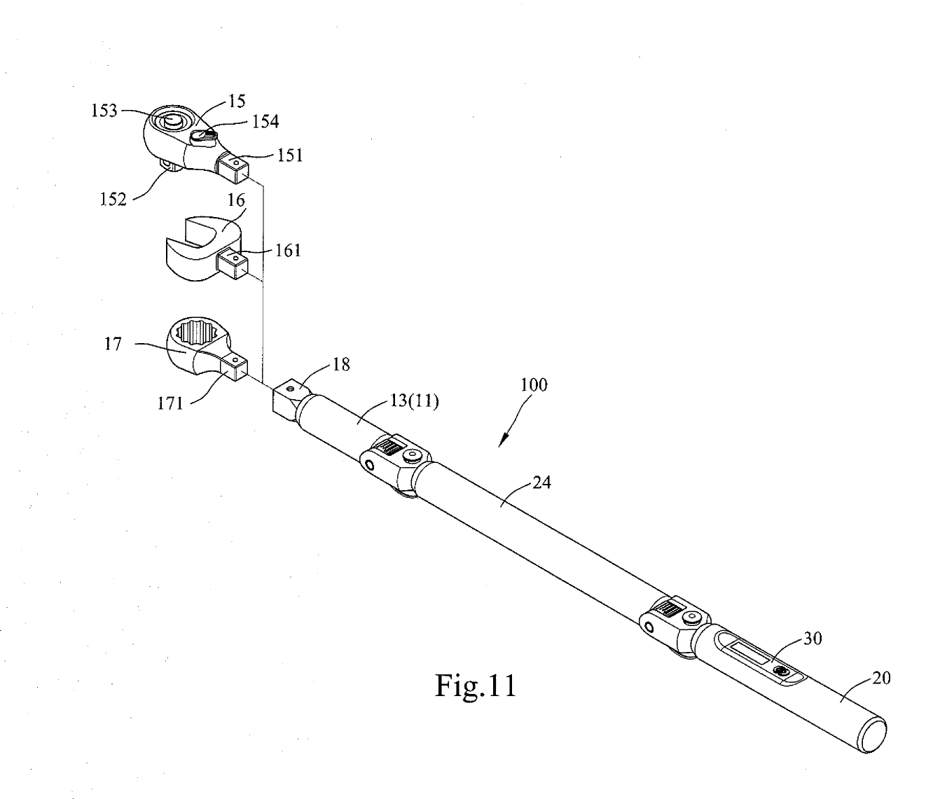

With reference to FIG. 11, to allow interchange of different driving portions 15, 16, 17, shank 11 can include an engaging section 18 spaced from pivotal portion 112 along longitudinal axis A. Detecting portion 111 is intermediate engaging section 18 and pivotal portion 112 along longitudinal axis A. Driving portion 15 is of the type similar to driving portion 12. Specifically, driving portion 15 includes a drive column 152, a ratcheting portion 153, and a switch 154, which can be of any desired form as conventional including but not limited to of a commercially available type. Each driving portion 15, 16, 17 includes an engaging end 151, 161, 171 for releasably engagement with engaging section 18. This also allows replacement of driving portions 15, 16, 17 of different sizes according to the size of the object to be driven.

According to the above, electronic torque wrenches 100 according to the teachings of the present invention provide precise detection of the torque applied to the object driven by driving portion 12, 15, 16, 17 regardless of the relative angular position between driving portion 12, 15, 16, 17 and handle 20 while avoiding damage to torque sensors 32 and 32′ and allowing replacement of driving portions 12, 15, 16, 17 of different types and different sizes.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An electronic torque wrench comprising, in combination:
a body (10) including a driving portion (12; 15; 16; 17) and a shank (11) interconnected to the driving portion (12; 15; 16; 17), with the shank (11) including a first pivotal portion (112) spaced from the driving portion (12; 15; 16; 17) along a first longitudinal axis (A), with the driving portion (12; 15; 16; 17) adapted to drive an object to rotate about a rotating axis perpendicular to the first longitudinal axis (A), with the shank (11) including a detecting portion (111) intermediate the first pivotal portion (112) and the driving portion (12; 15; 16; 17);
a handle (20) including a gripping section (22) and a second pivotal portion (212), with the second pivotal portion (212) pivotably connected to the first pivotal portion (112), with a torque display device (30) mounted to the handle (20); and
a torque sensor (32) mounted to the detecting portion (111) and electrically connected to the torque display device (30), with the torque sensor (32) adapted to detect toque applied from the driving portion (12; 15; 16; 17) to the object and to send a signal indicative of the torque to the torque display device (30), with the torque display device (30) adapted to receive the signal and to display a value of the torque.

2. The electronic torque wrench as claimed in claim 1, with the shank (11) including an engaging section (18) spaced from the first pivotal portion (112) along the first longitudinal axis (A), with the detecting portion (111) intermediate the first pivotal portion (112) and the engaging section (18) along the first longitudinal axis (A), with the driving portion (15; 16; 17) including an engaging end (151; 161; 171) releasably engaged with the engaging section (18).

3. The electronic torque wrench as claimed in claim 1, with the first pivotal portion (112) releasably engaged with the second pivotal portion (212).

4. The electronic torque wrench as claimed in claim 3, further comprising, in combination: an extension (23) mounted between the first and second pivotal portions (112, 212), with the extension (23) including a third pivotal portion (232) and a fourth pivotal portion (231) spaced from the third pivotal portion (231) along the first longitudinal axis (A), with the third pivotal portion (232) pivotably and releasably engaged with the first pivotal portion (112), with the fourth pivotal portion (231) pivotably and releasably engaged with the second pivotal portion (212).

5. The electronic torque wrench as claimed in claim 1, with the handle (20) including a rod (21) having the second pivotal portion (212), with the rod (21) further including a mounting portion (211) to which the torque display device (30) is mounted, with the handle (20) further including a jacket (26) mounted around the rod (21), with the jacket (26) including the gripping section (22), with the jacket (26) further including a window (221) aligned with the mounting portion (211), with the value of the torque viewable through the window (221).

6. The electronic torque wrench as claimed in claim 1, further comprising, in combination: a sleeve (13) mounted around the shank (11) and covering the detecting portion (111).

7. The electronic torque wrench as claimed in claim 1, with the second pivotal portion (212) spaced from the gripping section (22) along a second longitudinal axis (B), with the first pivotal portion (112) pivotable relative to the second pivotal portion (212) with an angle between the first and second longitudinal axis (A, B) not larger than 30°.

8. The electronic torque wrench as claimed in claim 1, with the torque sensor (32) electrically connected to the torque display device (30) by a wire (31), with the wire (31) extending around the first and second pivotal portions (112, 212).
